(19) United States
(12) Patent Application Publication
(10) Pub. No.: US 2026/0295636 A1
(43) Pub. Date: Oct. 1, 2026

(54) METHOD FOR MANUFACTURING A CMUT TRANSDUCER

(71) Applicant: VERMON, TOURS (FR)

(72) Inventors: Youngil KIM, TOURS (FR); Dominique GROSS, TOURS (FR); Nicolas SENEGOND, TOURS (FR)

(21) Appl. No.: 19/479,623

(22) PCT Filed: Apr. 22, 2024
(86) PCT No.: PCT/EP2024/060873

§ 371 Date: Oct. 28, 2025

(30) Foreign Application Priority Data
May 5, 2023 (FR) FR2304528

(51) Int. Cl. B06B 1/02

(52) U.S. Cl. CPC B06B 1/0292

(57) ABSTRACT

The present invention relates to a method for manufacturing a cMUT transducer, comprising the following steps: a) forming a first structure comprising a cavity (137) extending in a first silicon oxide layer (133) which coats one face of a first silicon layer (131); b) forming a lower metal electrode (141) of the transducer at the bottom of the cavity; c) forming a second structure comprising a second silicon layer (105); d) after steps a), b) and c), transferring and fixing the second structure onto the first structure by molecular bonding, so as to close the cavity.

The present application is based on and claims priority from French patent application FR2304528 filed on May 5, 2023, entitled “Method for manufacturing a CMUT transducer,” which is considered to be an integral part of the present disclosure within the limits provided by law.

### TECHNICAL FIELD

The present disclosure relates generally to the field of ultrasonic transducers and more particularly, the field of membrane capacitive ultrasonic transducers, also known as CMUT transducers (Capacitive Micromachined Ultrasonic Transducers).

### BACKGROUND ART

Conventionally, a CMUT transducer comprises a flexible membrane suspended above a cavity, a first electrode, called the lower electrode, located on the side of the cavity opposite to the membrane, and a second electrode, called the upper electrode, located on the side of the cavity opposite to the first electrode and mechanically integral with the flexible membrane. In operation, a direct current (DC) bias voltage is applied between the electrodes. When an appropriate alternating excitation voltage, superimposed on the DC bias voltage, is applied between the electrodes, the flexible membrane vibrates under the effect of the variation in the electrostatic force exerted between the electrodes, causing the emission of an ultrasonic acoustic wave. Conversely, when the transducer receives an ultrasonic acoustic wave, the flexible membrane vibrates under the effect of the variation in mechanical pressure, leading to the appearance, between the lower and upper electrodes of the transducer, of an alternating voltage superimposed on the direct current bias voltage, due to the variation in capacitance between the electrodes.

A CMUT transducer is typically coupled to an electronic control circuit configured for, during an emission phase, applying an alternating excitation voltage superimposed on a DC bias voltage between the electrodes of the transducer, so as to cause the transducer to emit an ultrasonic acoustic wave and, during a reception phase, applying a DC bias voltage between the electrodes of the transducer and reading between said electrodes an AC voltage generated under the effect of a received ultrasonic acoustic wave.

It would be desirable to have a method for manufacturing a CMUT transducer, which method would at least partially overcome some of the disadvantages of known methods for manufacturing a CMUT transducer.

### SUMMARY OF INVENTION

To this end, an embodiment provides a method for manufacturing a CMUT transducer, comprising the following steps:
a) forming a first structure comprising a cavity extending into a first silicon oxide layer coating a face of a first silicon layer;
b) forming a lower metal electrode of the transducer at the bottom of the cavity;
c) forming a second structure comprising a second silicon layer;
d) after steps a), b) and c), transferring and fixing the second structure onto the first structure by molecular bonding, so as to close the cavity.

According to an embodiment, the second structure comprises a second silicon oxide layer coating a face of the second silicon layer and, in step d), the second structure is fixed onto the first structure by molecular bonding of the second silicon oxide layer onto the first silicon oxide layer.

In an embodiment, the method comprises, prior to step d), a step of forming an upper metal electrode of the transducer on and in contact with the face of the second silicon oxide layer opposite to the second silicon layer.

According to an embodiment, the second silicon layer is non-intentionally doped or has a doping level less than 10¹³ atoms/cm³.

According to an embodiment, the second silicon layer has an electrical resistivity higher than 100 Ω·cm.

According to an embodiment, the method comprises, prior to the formation of the upper metal electrode, a step of forming conductive vias through the second silicon layer, the upper metal electrode of the transducer then being formed in contact with the conductive vias.

According to an embodiment, the second silicon layer has a doping level higher than 10¹⁶ atoms/cm³ and forms a non-metallic upper electrode of the transducer.

According to an embodiment, the second silicon layer has an electrical resistivity less than 0.2 Ω·cm and forms a non-metallic upper electrode of the transducer.

According to an embodiment, in step d), an annealing at a temperature between 70° and 1200° C., for example at a temperature in the order of 1100° C., is carried out after the transfer of the second structure onto the first structure.

According to an embodiment, the lower metal electrode of the transducer is made of a metal with a melting temperature higher than 1100° C., for example higher than 1500° C., for example higher than 1600° C.

According to an embodiment, the lower metal electrode of the transducer is made of molybdenum, platinum, titanium, tantalum, hafnium, iridium or tungsten.

According to an embodiment, the method comprises, after step d), a step e) of forming an opening located in the second silicon layer opposite to a peripheral part of the cavity, so as to expose a contact forming region of the lower metal electrode of the transducer, leading to the lateral reopening of the cavity.

According to an embodiment, the method comprises, after step e), a step of forming a sealing plug of a dielectric material, for example silicon oxide or silicon nitride, at the lateral opening of the cavity formed in step e).

According to an embodiment, the sealing plug is formed by physical vapor deposition, preferably at a pressure below atmospheric pressure.

### BRIEF DESCRIPTION OF DRAWINGS

The foregoing features and advantages, as well as others, will be described in detail in the following description of specific embodiments given by way of illustration and not limitation with reference to the accompanying drawings, in which:

FIG. 1A, FIG. 1B, FIG. 1C, FIG. 1D, FIG. 1E, FIG. 1F, FIG. 1G, FIG. 1H, FIG. 1I, FIG. 1J, FIG. 1K, FIG. 1L, FIG. 1M, FIG. 1N and FIG. 1O illustrate steps of an example of a method for manufacturing a CMUT transducer according to an embodiment;

FIG. 2 illustrates an example of an electrode pattern of a CMUT transducer of the type described in relation to FIGS. 1A to 1O;

FIG. 3 is an enlarged perspective view of a portion of a CMUT transducer of the type described in relation to FIGS. 1A to 1O;

FIG. 4A, FIG. 4B, FIG. 4C and FIG. 4D illustrate steps of another example of a method for manufacturing a CMUT transducer according to an embodiment; and

FIG. 5 illustrates yet another example of a method for manufacturing a CMUT transducer according to an embodiment.

### DESCRIPTION OF EMBODIMENTS

Like features have been designated by like references in the various figures. In particular, the structural and/or functional features that are common among the various embodiments may have the same references and may dispose identical structural, dimensional and material properties.

For the sake of clarity, only the steps and elements that are useful for an understanding of the embodiments described herein have been illustrated and described in detail. In particular, the various applications that the transducers described may not have been detailed, as the embodiments described are compatible with the usual applications of ultrasonic transducers, particularly in ultrasonic imaging devices. Furthermore, the control circuits for the transducers described have not been detailed, as the embodiments described are compatible with all or most known CMUT transducer control circuits.

In the present description, unless indicated otherwise, a CMUT transducer is a device composed of one or more CMUT transduction elements arranged according to the requirements of the application. Each CMUT transduction element consists of one or more CMUT transduction elementary cells connected electrically to each other, for example in parallel. Each CMUT elementary cell comprises, for example, a single flexible membrane suspended above a cavity and two opposing electrodes adapted to receive an electrical excitation signal to vibrate the membrane and/or to generate an electrical response signal under the effect of a vibration of the membrane.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following disclosure, when reference is made to absolute positional qualifiers, such as the terms “front”, “back”, “top”, “bottom”, “left”, “right”, etc., or to relative positional qualifiers, such as the terms “above”, “below”, “higher”, “lower”, etc., or to qualifiers of orientation, such as “horizontal”, “vertical”, etc., reference is made to the orientation illustrated in the figures, unless indicated otherwise.

Unless indicated otherwise, the expressions “about” “approximately,” “substantially,” and “in the order of” mean within 10%, preferably within 5%.

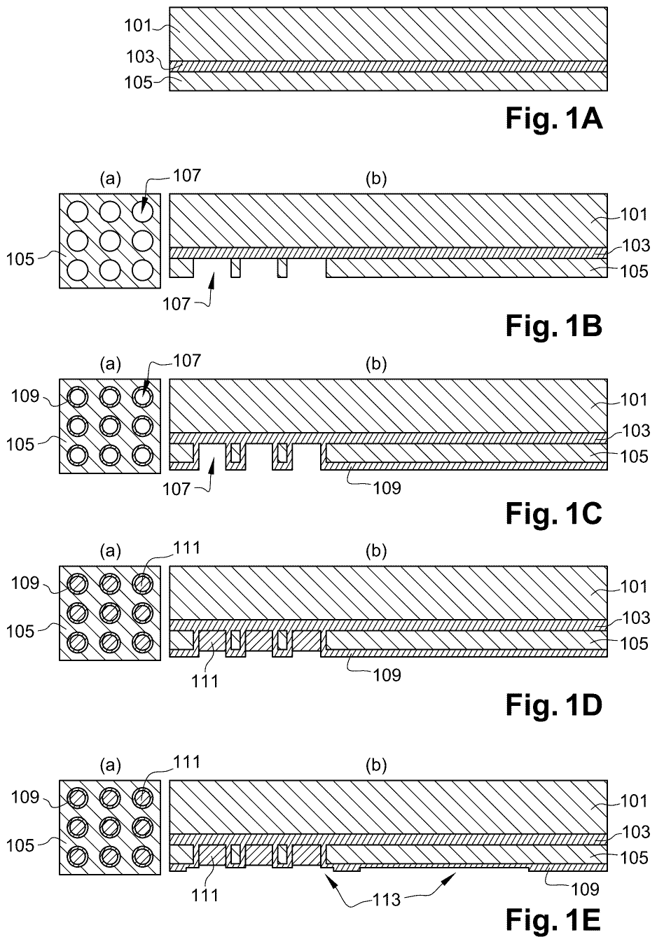

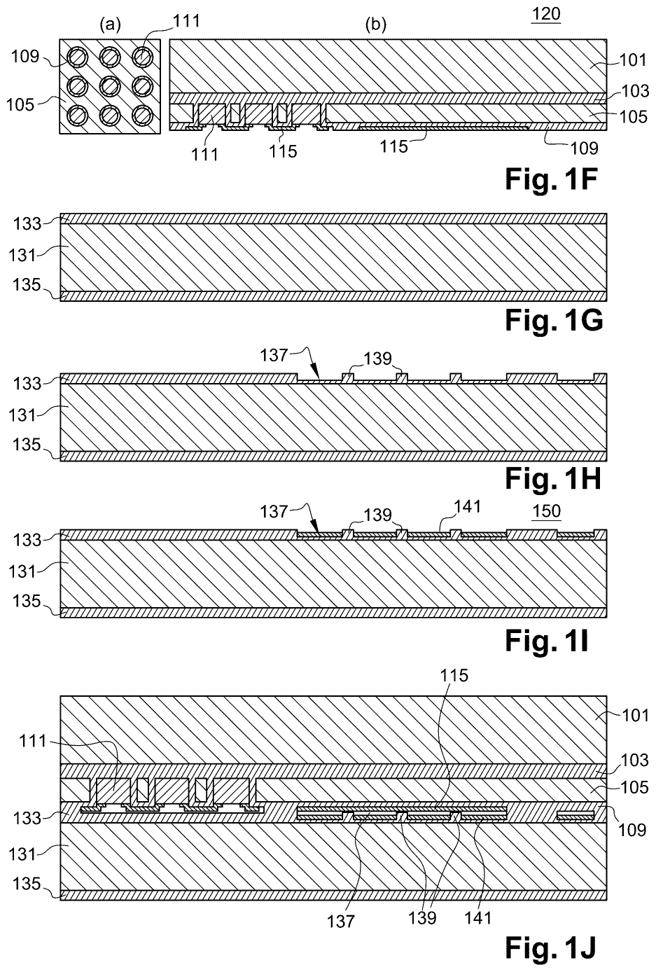

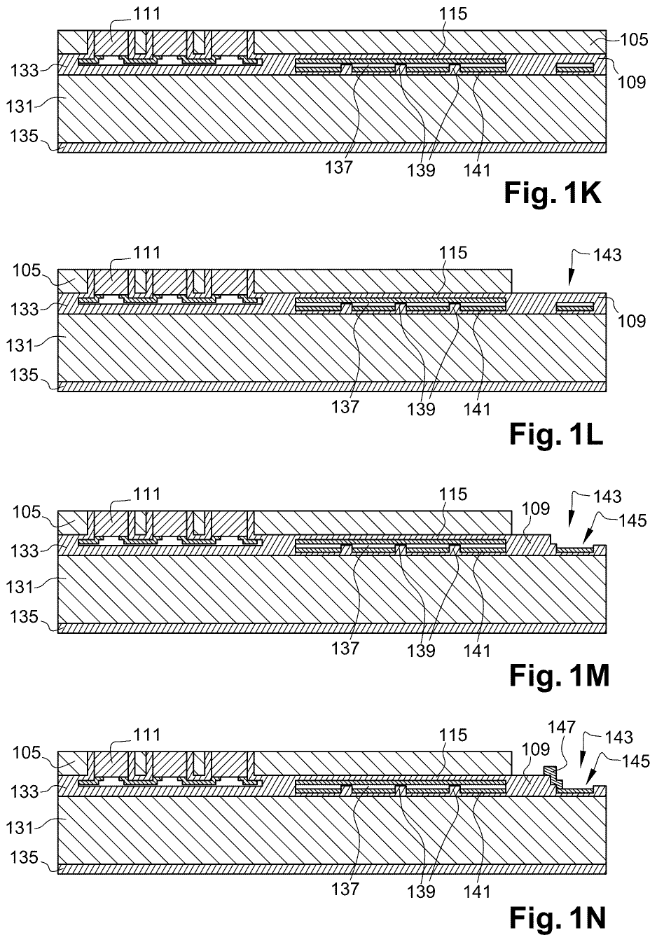

FIGS. 1A to 1O illustrate steps of an example of a method for manufacturing a CMUT transducer according to an embodiment. FIGS. 1A to 1O illustrate the production of a single CMUT transducer elementary cell. In practice, a large number of cells can be produced simultaneously from a same starting substrate.

FIGS. 1A to 1F illustrate successive steps of the production of a structure 120 comprising, in particular, the flexible membrane and the upper electrode of the CMUT transducer.

FIG. 1A illustrates a starting stack of SOI type (Semiconductor On Insulator) comprising a silicon support substrate 101, a silicon oxide layer 103 coating a face, the lower face in the orientation of FIG. 1A, of the substrate 101, and a silicon layer 105 coating the face of the silicon oxide layer 103 opposite to the substrate 101. For example, each of the layers 103 and 105 extends continuously and with a substantially uniform thickness over the entire surface of the substrate 101. In this example, the substrate 101 is in contact, via its lower face, with the upper face of the layer 103, and the layer 105 is in contact, via its upper face, with the lower face of the layer 103. The substrate 101 corresponds, for example, to a silicon wafer or a portion of a silicon wafer.

The thickness of the substrate 101 is, for example, between 10 μm and 1 mm, for example between 400 and 800 μm. The thickness of the silicon oxide layer 103 is, for example, between 50 nm and 2 μm. The thickness of the silicon layer 105 is, for example, between 0.2 and 10 μm. The silicon layer 105 is preferably highly resistive. For example, the silicon layer 105 has a relatively low doping level, for example less than 10¹³ atoms/cm³. The layer 105 is, for example, non-intentionally doped. For example, the layer 105 has an electrical resistivity higher than 100 Ω·cm.

In this example, the silicon layer 105 corresponds to the future flexible membrane of the transducer.

FIG. 1B illustrates a step of forming, for each elementary cell of the transducer, one or more holes 107 in the silicon layer 105, in view of forming one or more conductive vias for making contact with the upper electrode of the elementary cell of the transducer. In this example, several small holes 107 are formed in a peripheral region of each elementary cell of the transducer.

FIG. 1B, as well as FIGS. 1C, 1D, 1E and 1F described below, each include a vertical cross-sectional view b) of the structure and a partial horizontal cross-sectional view a) in a plane between the lower face and the upper face of the silicon layer 105, representing the peripheral region where the holes 107 are formed.

In the illustrated example, nine holes 107 arranged in a matrix of three rows and three columns are formed for each elementary cell of the transducer. However, the described embodiments are not limited to this particular arrangement.

For example, the width of each hole 107 is between 0.5 and 100 μm. The holes have, for example, in a top view, a circular, square, rectangular or polygonal shape.

The holes 107 are formed from the lower face of the layer 105 and open into the silicon oxide layer 103 or onto the lower face of the silicon oxide layer 103.

The holes 107 are formed, for example, by photolithography and etching.

FIG. 1C illustrates a step of forming a silicon oxide layer 109 on the lower face of the structure illustrated in FIG. 1A. The layer 109 is formed, for example, by thermal oxidation of the silicon layer 105. Thus, the layer 109 is formed, for example, with a substantially constant thickness, on the lower face of the layer 105 and on the side walls of the holes 107. The thickness of the layer 109 is, for example, between 1 and 20 μm.

FIG. 1D illustrates a step of filling the holes 107 with metal to form conductive vias 111. The metal used to fill the holes 107 preferably has a high melting temperature, for example, higher than 1100° C., for example, higher than 1500° C., for example, higher than 1600° C. As a preferred example, the metal used to fill the holes 107 is molybdenum (Mo). As a variant, the metal may be platinum (Pt), titanium (Ti), tantalum (Ta), hafnium (Hf), iridium (Ir) or tungsten (W). The metal can be deposited in the holes 107 by physical vapor deposition, for example by sputter deposition, by electron beam evaporation and electroplating, or by electroless plating after forming a localized metal seed layer at the bottom and on the side walls of the holes 107 (e.g., by a full-plate deposition followed by a localized etching).

FIG. 1E illustrates a localized etching step, for example by photolithography, of a part of the thickness of the silicon oxide layer 109, so as to form in the layer 109, in each elementary cell of the transducer, a recess 113 intended to accommodate the upper electrode of the elementary cell. In this example, a part of the thickness of the layer 109 is retained at the bottom of the recess 113 so as to electrically insulate the future upper electrode from the silicon layer 105.

In this example, the recess 113 is located mainly in a central part (when viewed from below) of the structure, intended to be positioned opposite to the future cavity of the transducer's elementary cell. The recess 113 also extends opposite to the peripheral part comprising the vias 111, to allow the forming of an electrical connection with the upper electrode via the vias 111.

FIG. 1F illustrates a step of forming an upper electrode 115 of the transducer, located in the recess 113. In this example, the electrode 115 is metallic. The electrode 115 is, for example, formed by a full-plate deposition followed by a localized etching of a metal layer. In this example, the electrode 115 is entirely located in the recess 113 and has a thickness less than or equal to the depth of the recess 113. Thus, in this example, the lower face of the upper electrode 115 is recessed from the lower face of the parts of the silicon oxide layer 109 not etched in the step of FIG. 1E, or is flush with the lower face of the parts of the silicon oxide layer 109 not etched in the step of FIG. 1E. The electrode 115 extends, for example, over substantially the entire surface of the recess 113 and is in contact, via its upper face, with the lower face of the metal vias 111.

The metal used to form the electrode preferably has a high melting temperature, for example higher than 1100° C., for example higher than 1500° C., for example higher than 1600° C. The metal used to form the electrode 115 may be the same as or different from the metal used to form the vias 111. As a preferred example, the metal used to form the electrode 115 is molybdenum (Mo). As a variant, the metal may be platinum (Pt), titanium (Ti), tantalum (Ta), hafnium (Hf), iridium (Ir) or tungsten (W).

Reference 120 refers to the structure obtained at the end of this step, comprising in particular the upper electrode 115 and the future flexible membrane 105 of the CMUT transducer, as well as conductive vias 115 passing through the membrane 105 and allowing the electrode 115 to be connected to an external control circuit.

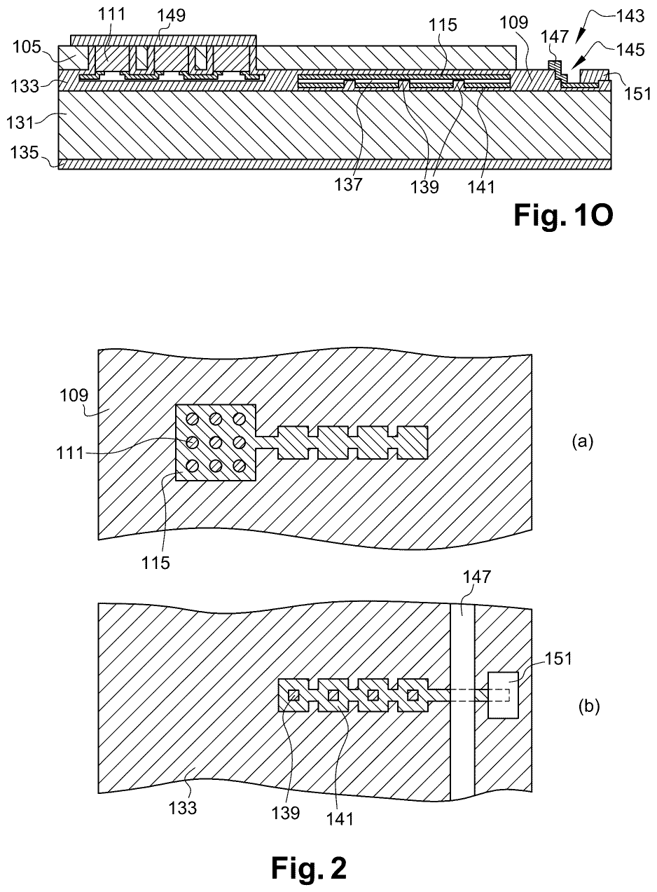

View (a) in FIG. 2 illustrates the shape, in this example, when viewed from below, of the upper electrode 115 of the transducer, corresponding substantially to the shape of the recess 113 formed in the step illustrated in FIG. 1E.

FIGS. 1G to 1I illustrate successive steps of the production of a structure 150 comprising, in particular, the lower electrode of the CMUT transducer.

FIG. 1G illustrates a step of oxidizing a silicon substrate or layer 131. The substrate 131 corresponds, for example, to a silicon wafer or a portion of a silicon wafer. The substrate 131 has, for example, the same lateral dimensions as the substrate 101. The thickness of the substrate 131 is, for example, between 10 μm and 1 mm, for example between 400 and 800 μm. The substrate 131 is preferably highly resistive. For example, the substrate 131 has a relatively low doping level, for example less than 10¹³ atoms/cm³. The substrate 131 is, for example, non-intentionally doped.

During this step, a silicon oxide layer 133 is formed on and in contact with the upper face of the substrate 131. The thickness of the silicon oxide layer 133 is, for example, between 100 nm and 800 nm. In the illustrated example, a silicon oxide layer 135 is also formed on and in contact with the lower face of the substrate 131 during this step.

FIG. 1H illustrates a step of localized etching, for example by photolithography and etching, of a part of the thickness of the silicon oxide layer 133, so as to form in the layer 133, in each elementary cell of the transducer, a recess 137 intended to accommodate the lower electrode of the elementary cell and defining the cavity of the elementary cell.

In this example, two successive etchings are performed to form the recess 137, so as to obtain two distinct etching depths in distinct regions of the recess 137. More specifically, during the first etching, a first thickness of the layer 133 is removed over the entire surface of the recess 137, and during the second etching, one or more portions 139 of the insulating layer 133 in the form of islands are left intact (i.e., not etched) in a central part of the transducer cavity. The portions 139 form mechanical stop pads that prevent a possible short circuit between the lower and upper electrodes of the transducer in the event of a collapsing of the flexible membrane.

In this example, a part of the thickness of the layer 133 is retained at the bottom of the recess 137 so as to electrically insulate the future lower electrode from the silicon substrate 131.

In this example, the recess 137 is located mainly in a central part (when viewed from above) of the structure, intended to be positioned opposite to the future cavity of the transducer's elementary cell. The recess 137 also extends opposite to a peripheral part of the transducer, for example located on the side of the cavity opposite to the peripheral region comprising the vias 111, to allow an electrical contact to be formed with the lower electrode of the transducer.

FIG. 1I illustrates a step of forming a lower electrode 141 of the transducer, located in the recess 137. The electrode extends at the bottom of the recess 137 and is interrupted at the pads 139, i.e., it surrounds the pads 139 laterally. The thickness of the electrode 141 is less than the height of the pads 139. Thus, the upper face of the electrode 141 is recessed from the upper face of the pads 139, which is itself recessed from the upper face of the layer 133 outside the recess 137. In this example, the height of the CMUT transducer cavity is defined by the distance between the plane of the upper face of the electrode 141 and the plane of the upper face of the silicon oxide layer 133. The height of the cavity is, for example, between 10 nm and 1 μm.

In this example, the electrode 141 is metallic. The electrode 141 is, for example, formed by a full-plate deposition followed by a localized etching of a metallic layer. The metal used to form the electrode preferably has a high melting temperature, for example higher than 1100° C., for example higher than 1500° C., for example higher than 1600° C. The metal used to form the electrode 141 may be identical to or different from the metal used to form the lower electrode 115. As a preferred example, the metal used to form the electrode 141 is molybdenum (Mo). As a variant, the metal may be platinum (Pt), titanium (Ti), tantalum (Ta), hafnium (Hf), iridium (Ir) or tungsten (W).

Reference 150 refers to the structure obtained at the end of this step, comprising in particular the lower electrode 141 and the recess 137 defining the future cavity of the transducer.

View (b) in FIG. 2 illustrates the shape, in this example, in a top view, of the lower electrode 141 of the transducer.

FIGS. 1J to 1O are vertical cross-sectional views illustrating successive steps in the manufacture of the transducer from the structures 120 and 150 in FIGS. 1F and 1I.

FIG. 1J illustrates a step during which the structure 120 of FIG. 1F is transferred and fixed onto the structure 150 of FIG. 1I.

More specifically, during this step, the structure 120 of FIG. 1F is fixed onto the structure 150 by direct bonding or molecular bonding of the lower face of the silicon oxide layer 109 onto and in contact with the upper face of the silicon oxide layer 133. This step is preferably carried out under vacuum.

This closes the cavity 137 of the transducer, the lower electrode 141 and the upper electrode 115 being placed opposite to each other inside the cavity, respectively on the side of the lower wall and on the side of the upper wall of the cavity.

To improve the quality of the bonding, an annealing of the structure at a relatively high temperature is preferably performed after transfer. The annealing is carried out at a temperature less than the melting temperature of the metals comprising the vias 111, the upper electrode 115 and the lower electrode 141, for example at a temperature between 70° and 1200° C., for example at a temperature in the order of 1100° C. This is referred to as fusion bonding.

At the end of this step, the transducer cavity is hermetically sealed.

FIG. 1K illustrates a step of removal, for example by grinding and/or etching, of the support substrate 101 and the buried silicon oxide layer 103 from the side of the upper face of the assembly. At the end of this step, the upper face of the silicon layer 105, forming the flexible membrane of the transducer, is exposed. The upper face of the vias 111 is also exposed and flushes with the upper face of the layer 105.

FIG. 1L illustrates a step of forming, for example by photolithography and etching, a localized opening 143 in the silicon layer 105, directly above a peripheral contact forming region on the lower electrode 141 of the transducer. In the example illustrated, the etching is interrupted on the upper face of the silicon oxide layer 109.

FIG. 1M illustrates a step of localized removal of the silicon oxide layer 109 at the bottom of the opening 143, so as to expose the upper face of the lower electrode 141 of the transducer in the peripheral contact forming region. During this step, a through opening 145 is formed in the silicon oxide layer 109 at the bottom of the opening 143. When viewed from above, the surface of the opening 145 is, for example, smaller than the surface of the opening 143.

During this step, the cavity 137 of the transducer, which was previously hermetically sealed in the step illustrated in FIG. 1J, is locally reopened, i.e., the cavity is reconnected to the outside atmosphere.

FIG. 1N illustrates a step of forming a sealing joint or plug 147 made of an electrically insulating material, for example silicon oxide (SiO₂) or silicon nitride (SiNₓ) on the flank of the opening 145 in contact with the cavity 137, and around the junction area between the central part of the lower electrode 141 located in the transducer cavity and the peripheral contact forming region of the electrode 141 located outside the cavity. The joint 147 then blocks the lateral opening of the cavity formed in the step illustrated in FIG. 1M. The material of the joint 147 is preferably deposited under vacuum, i.e., under a pressure below atmospheric pressure, so as to obtain a cavity with a pressure below atmospheric pressure. The material of the joint 147 is, for example, deposited by chemical vapor deposition, for example by PE-CVD (Plasma Enhanced Chemical Vapor Deposition). For example, the material is first deposited as a full plate over the entire upper face of the structure, then removed locally, for example by photolithography and etching, so that it remains only in the vicinity of the lateral opening of the cavity formed in the step illustrated in FIG. 1M.

At the end of this step, the cavity 137 is hermetically sealed again, preferably under a pressure below atmospheric pressure.

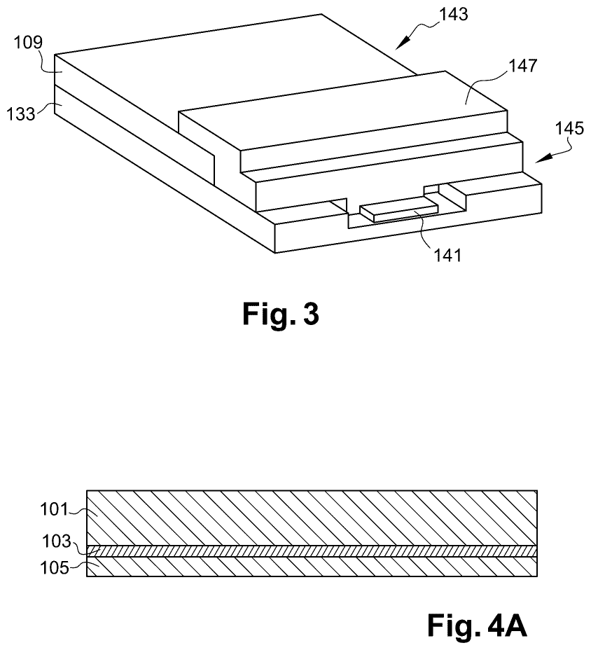

FIG. 3 is an enlarged perspective view illustrating in more detail the arrangement of the sealing joint 147 in the opening 143.

FIG. 1O illustrates a step of forming, on the side of the upper face of the transducer, electrical connection pads 149 and 151 (not connected to each other) respectively on and in contact with the upper face of the conductive vias 111 and on and in contact with the upper face of the portion of the lower electrode 141 exposed in the step of FIG. 1M.

The pads 149 and 151 are thus connected respectively to the upper electrode 115 and the lower electrode 141 of the CMUT transducer and allow to electrically bias and/or excite the transducer and/or to read electrical signals generated by the transducer.

The pads 149 are, for example, metallic, for example made of copper, aluminum or an alloy based on one or more of these materials. In this example, the pad 149 does not extend over the flexible membrane 105 opposite to the central part of the cavity 137 of the CMUT transducer.

An advantage of the method presented in relation to FIGS. 1A to 1O, 2 and 3 is that it allows to manufacture a CMUT transducer whose upper and lower electrodes are both metallic, thereby minimizing the access resistance to these electrodes. In particular, this reduces the access resistance compared to CMUT transducers whose electrodes are made of silicon. The use of high-melting-temperature metals allows to carry out a fusion bonding assembly method, resulting in a transducer with high robustness and reliability. The electrical connection of all the transducer electrodes to an external device can then be made on the same face of the transducer, for example by wire bonding.

In the illustrated example, the use of a plurality of small conductive vias 111 topped by a connection pad 149 to connect the upper electrode 115 to the outside advantageously provides a stable and robust contact forming structure.

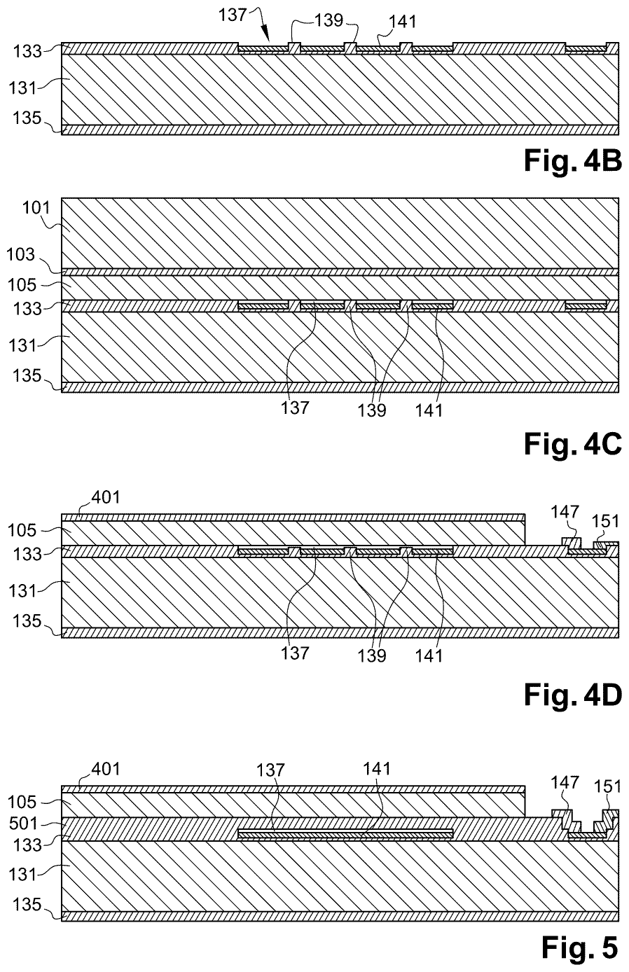

FIGS. 4A to 4D are vertical cross-sectional views illustrating steps of another example of a method for manufacturing a CMUT transducer according to an embodiment.

The method of FIGS. 4A to 4D differs from the method described above mainly in that, in the example of FIGS. 4A to 4D, the CMUT transducer does not comprise a metal upper electrode inside the cavity. In this example, the silicon layer 105 forming the flexible membrane of the transducer is heavily doped and also forms the upper electrode of the transducer.

FIG. 4A illustrates a structure corresponding to an SOI-type stack, similar to that of FIG. 1A. In this example, the silicon layer 105 is heavily doped. For example, the doping level of the silicon layer 105 is higher than 10¹⁶ atoms/cm³, for example higher than or equal to 10¹⁸ atoms/cm³, for example, the layer 105 has an electrical resistivity less than 0.2 Ω·cm.

FIG. 4B illustrates another structure identical or similar to the structure of FIG. 1I and produced in substantially the same manner.

FIG. 4C illustrates a step of transferring and fixing the stacking of FIG. 4A onto the structure of FIG. 4B.

More specifically, during this step, the structure of FIG. 4A is fixed onto the structure of FIG. 4B by direct bonding or molecular bonding. In this example, the bonding is a direct bonding of silicon to silicon oxide. More specifically, the lower face of the silicon layer 105 is bonded by direct bonding onto and in contact with the upper face of the silicon oxide layer 133.

This hermetically seals the cavity 137 of the CMUT transducer.

To improve the quality of the bonding, the bonding is preferably a fusion bonding, i.e., an annealing of the structure at a relatively high temperature is provided after the transfer, for example, at a temperature between 70° and 1200° C., for example, at a temperature in the order of 1100° C.

The following steps are, for example, identical or similar to the steps described in relation to FIGS. 1K, 1L, 1M, 1N and 1O. It should be noted that, in this example, the doped silicon constituting the membrane may optionally be etched to electrically isolate portions of the membrane.

FIG. 4D illustrates the structure obtained at the end of these steps. As illustrated in FIG. 4D, in this example, the electrical connection pad 149 of the structure in FIG. 1O is replaced by a metal layer 401 extending onto and in contact with the upper face of the silicon layer 105. The layer 401 extends, for example, over the entire surface of the flexible membrane 105 opposite to the central part of the cavity 137 of the CMUT transducer.

FIG. 5 is a vertical cross-sectional view illustrating yet another example of a method for manufacturing a CMUT transducer according to an embodiment.

FIG. 5 illustrates the final structure obtained at the end of the method.

The method of FIG. 5 differs from the method of FIGS. 4A to 4D mainly in that, in the example of FIG. 5, a silicon oxide layer 501 is formed on and in contact with the lower face of the silicon layer 105. The layer 501 is formed, for example, between the step of FIG. 4A and the step of FIG. 4C, for example by thermal oxidation of the lower face of the layer 105 of the stack in FIG. 4A.

The bonding carried out in the step of FIG. 4B is then a direct bonding of silicon oxide to silicon oxide. More specifically, the lower face of the silicon oxide layer 501 is bonded by direct bonding, preferably by fusion bonding, onto and in contact with the upper face of the silicon oxide layer 133.

The rest of the method is identical or similar to that described above.

Thus, in this example, the silicon oxide layer 501 extends over the entire lower face of the flexible membrane 105 opposite to the lower electrode 141 of the CMUT transducer. This prevents any direct electrical contact between the upper electrode (i.e., the layer 105) and the lower electrode 141 in the event of a collapsing of the CMUT transducer membrane.

In particular, this allows the transducer to operate in a mode known as collapsed mode. In this operating mode, a DC bias voltage is applied between the lower and upper electrodes of the transducer such that the flexible membrane collapses, so that the lower face of the silicon oxide layer 501 remains in permanent contact with the upper face of the lower electrode 141 in a central part of the cavity 137 of the CMUT transducer. In this case, the stop pads 139 formed in the cavity 137 may be omitted.

Various embodiments and variants have been described. Those skilled in the art will understand that certain features of these embodiments can be combined and other variants will readily occur to those skilled in the art. In particular, the embodiments described are not limited to the examples of materials and dimensions mentioned in the description.

Furthermore, in the examples described above, the cavity of the CMUT transducer is defined by structuring (recess 137) the silicon oxide layer 133 coating the upper face of the substrate 131. As a variant, the cavity may be defined by structuring a silicon oxide layer formed on the side of the lower face of the silicon layer 105 forming the flexible membrane of the transducer.

1. A method for manufacturing a CMUT transducer,
comprising the following steps:
a) forming a first structure comprising a cavity extending into a first silicon oxide layer coating a face of a first silicon layer;
b) forming a lower metal electrode of the transducer at the bottom of the cavity;
c) forming a second structure comprising a second silicon layer; and
d) after steps a), b) and c), transferring and fixing the second structure onto the first structure by molecular bonding, so as to close the cavity,
wherein the second structure comprises a second silicon oxide layer coating a face of the second silicon layer, and wherein, in step d), the second structure is fixed onto the first structure by molecular bonding of the second silicon oxide layer onto the first silicon oxide layer,
the method comprising, prior to step d), a step of forming an upper metal electrode of the transducer on and in contact with the face of the second silicon oxide layer opposite to the second silicon layer, and
the method further comprising, prior to forming the upper metal electrode, a step of forming conductive vias through the second silicon layer, the upper metal electrode of the transducer then being formed in contact with the conductive vias.

2. The method according to claim 1, wherein the second silicon layer is non-intentionally doped or has a doping level less than 10¹³ atoms/cm³.

3. The method according to claim 1, wherein the second silicon layer has an electrical resistivity higher than 100 Ω·cm.

4. The method according to claim 1, wherein, in step d), an annealing at a temperature between 70° and 1200° C., for example at a temperature in the order of 1100° C., is carried out after the transfer of the second structure onto the first structure.

5. The method according to claim 1, wherein the lower metal electrode of the transducer is made of a metal having a melting temperature higher than 1100° C., for example higher than 1500° C., for example higher than 1600° C.

6. The method according to claim 1, wherein the lower metal electrode of the transducer is made of molybdenum, platinum, titanium, tantalum, hafnium, iridium, or tungsten.

7. The method according to claim 1, comprising, after step d), a step e) of forming an opening located in the second silicon layer opposite to a peripheral part of the cavity, so as to expose a contact forming region of the lower metal electrode of the transducer, leading to the lateral reopening of the cavity.

8. The method according to claim 7, comprising, after step e), a step of forming a sealing plug of a dielectric material, for example silicon oxide or silicon nitride, at the lateral opening of the cavity formed in step e).

9. The method according to claim 8, wherein the sealing plug is formed by physical vapor deposition, preferably at a pressure below atmospheric pressure.
